(19) United States
(12) Patent Application Publication
(10) Pub. No.: US 2005/0179914 A1
(43) Pub. Date: Aug. 18, 2005

(54) Image forming apparatus and image forming method

(75) Inventor: Hiroyuki Fuse, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/054,123

(22) Filed: Feb. 8, 2005

(30) Foreign Application Priority Data
Feb. 13, 2004 (JP) 2004-036962

(51) Int. Cl. H04N 1/393; G06F 3/12

(52) U.S. Cl. 358/1.2; 358/449; 358/451; 358/1.13

(57) ABSTRACT

An image forming apparatus has a reading section which reads an image of a gradation document placed on a document stage, a selecting section which selects any one of an auto mode and a manual mode, a determining section which, when the manual mode has been selected, determines a size of the gradation document in response to a user instruction, and, when the auto mode has been selected, automatically determines a size of the gradation document read, an image processing section which determines a magnification based on the size of the gradation document and a size of a recording medium set in response to the user instruction, and magnifies the image of the gradation document according to the determined magnification, and an image forming section which forms an image on the recording medium.

### CROSS-REFERENCE TO RELATED APPLICATIONS

This application is based upon and claims the benefit of priority from prior Japanese Patent Application No. 2004-036962, filed Feb. 13, 2004, the entire contents of which are incorporated herein by reference.

### BACKGROUND OF THE INVENTION

1. Field of the Invention

The present invention relates to an image forming apparatus, and more particularly, to an image forming apparatus and an image forming method for copying a photographic document.

2. Description of the Related Art

With the improved performance of an image forming apparatus such as a digital copying machine, a comprehensive digital device having a printer function as well as a copying function has become recently prevalent since it was developed. In such an image forming apparatus, for example, there is a demand for an additional function which can flexibly cope with an image with its gradation property such as a photographic image while an image with its very high quality is formed.

In response to this demand, for example, in a conventional image forming apparatus, there is known that, when a photography size is inputted from an operating screen, paper of the corresponding size is selected, and a photographic image is formed on this paper (for example, Jpn. Pat. Appln. KOKAI Publication No. 11-234483).

However, in the conventional image forming apparatus, there has been a problem that it is not known as to how to cope with a case in which the photography size does not conform with the Japanese standard or a case in which the size does not conform with an existing standard.

### BRIEF SUMMARY OF THE INVENTION

An image forming apparatus according to an embodiment of the present invention comprises: a reading section which reads an image of a gradation document placed on a document stage; a selecting section which selects any one of an auto mode and a manual mode; a determining section which, when the manual mode has been selected by the selecting section, determines a size of the gradation document in response to a user instruction, and, when the auto mode has been selected by the selecting section, automatically detects and determines a size of the gradation document read by the reading section; an image processing section which determines a magnification based on the size of the gradation document determined by the determining section and a size of a recording medium set in response to the user instruction, and magnifies the image of the gradation document according to the determined magnification; and an image forming section which forms an image on the recording medium based on image information processed by the image processing section.

### BRIEF DESCRIPTION OF THE SEVERAL VIEWS OF THE DRAWING

FIG. 1 is a view showing an example of displaying a basic screen for use in North America at an operating section of an image forming apparatus according to the present invention;

FIG. 2 is a view showing an example of displaying a photo zoom for use in North America at the operating section of the image forming apparatus;

FIG. 3 is a view showing an example of displaying the photo zoom for use in North America at the operating section of the image forming apparatus;

FIG. 4 is a sectional view showing an example of a configuration of the image forming apparatus;

FIG. 5 is a block diagram depicting an example of the configuration of the image forming apparatus;

FIG. 6 is a view showing an example of displaying a custom size for use in North America at the operating section of the image forming apparatus;

FIG. 7 is a view showing an example of displaying a basic screen for use in Europe at the operating section of the image forming apparatus;

FIG. 8 is a view showing an example of displaying a photo zoom for use in Europe at the operating section of the image forming apparatus;

FIG. 9 is a view showing an example of displaying a custom size for use in Europe at the operating section of the image forming apparatus;

FIG. 10 is a view showing an example of displaying a basic screen for use in Japan at the operating section of the image forming apparatus;

FIG. 11 is a view showing an example of displaying a photo zoom for use in Japan at the operating section of the image forming apparatus;

FIG. 12 is a view showing an example of displaying a custom size for use in Japan at the operating section of the image forming apparatus;

FIG. 13 is a view showing a relationship among a printing paper size name, an actual size and a copying magnification handled by the image forming apparatus;

FIG. 14 is a flow chart showing an example of a copying process of a photographic document in the image forming apparatus;

FIG. 15 is a flow chart showing an example of a copying process with automatic size recognition of the photographic document in the image forming apparatus;

FIG. 16 is a view showing an example of an operating screen for selecting a photographic size sequence in the image forming apparatus;

FIG. 17 is a view showing an example of an operating screen for selecting an arbitrary photographic size in the image forming apparatus;

FIG. 18 is a view showing an example of an operating screen depending on an arbitrary photographic size in the image forming apparatus;

FIG. 19 is a view showing an example of a photographic image outputted by the image forming apparatus;

FIG. 20 is a view showing an example of a flow chart when selecting an arbitrary photographic size sequence in the image forming apparatus; and

FIG. 21 is a view showing an example of a flow chart when selecting an arbitrary photographic size sequence in the image forming apparatus.

### DETAILED DESCRIPTION OF THE INVENTION

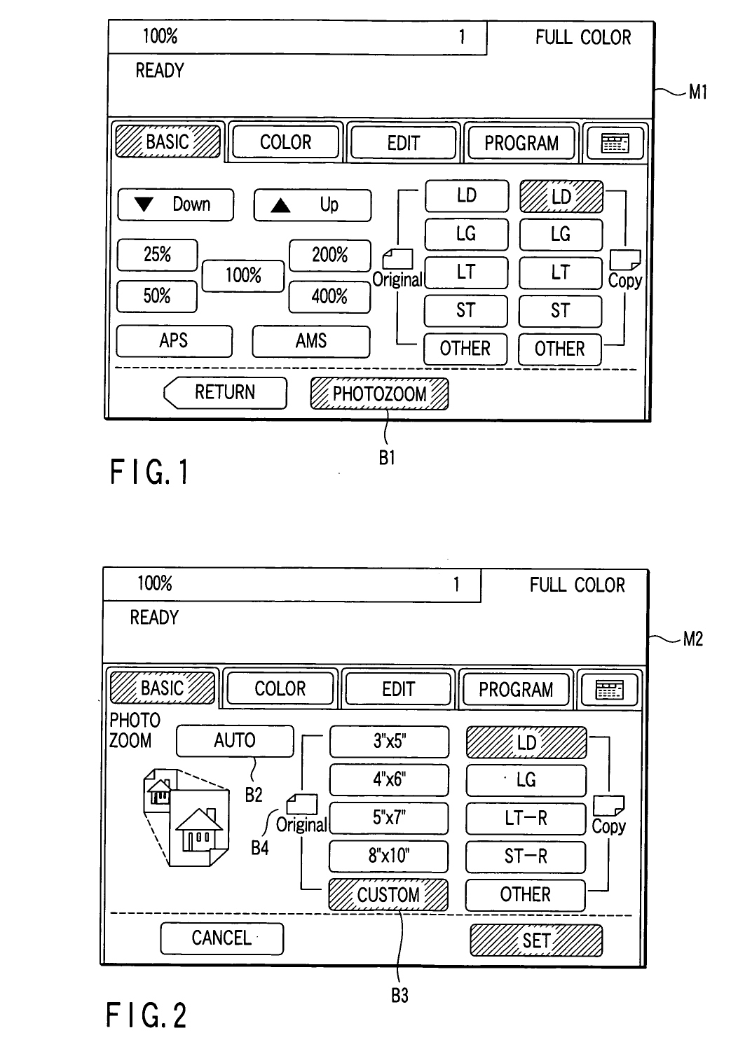

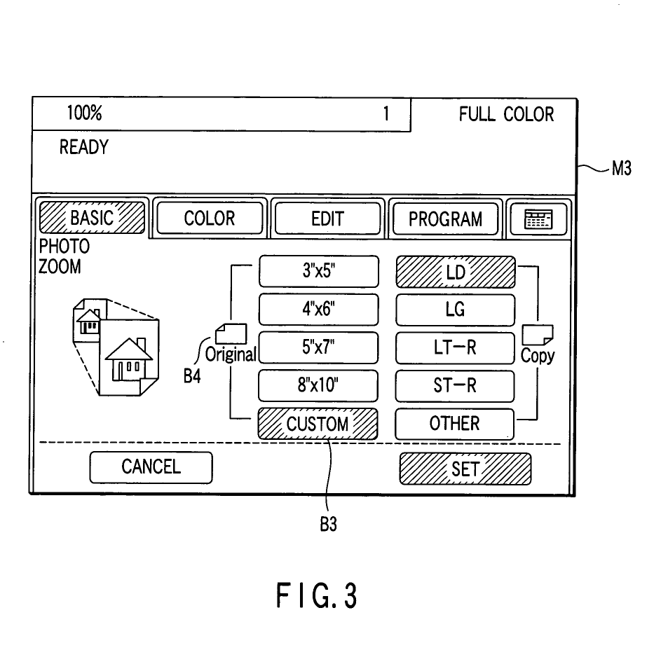

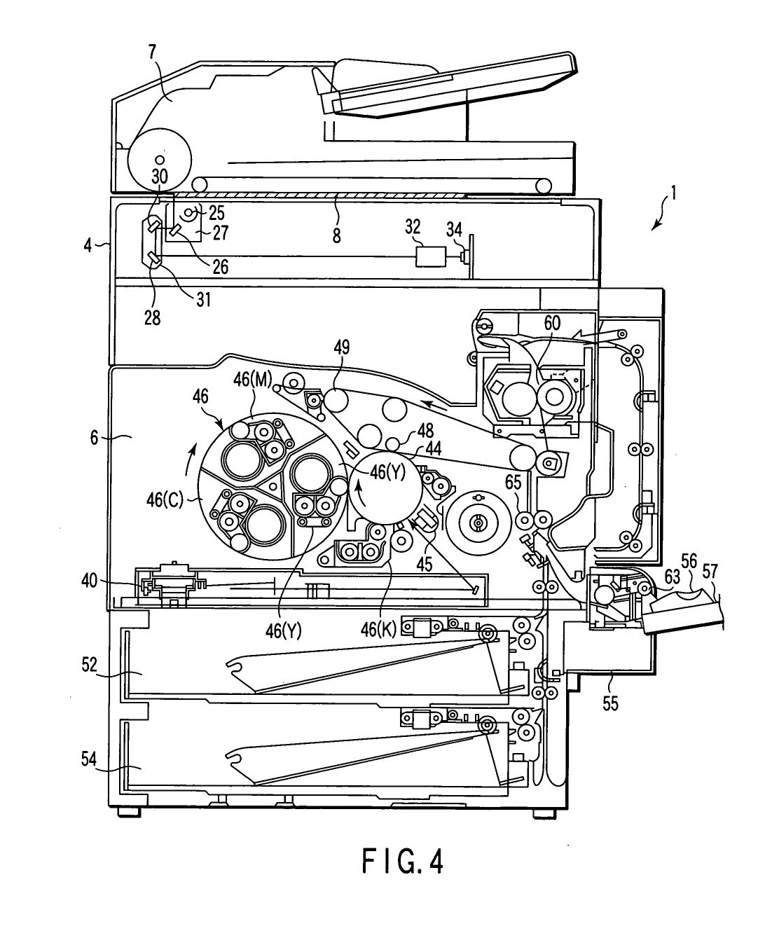

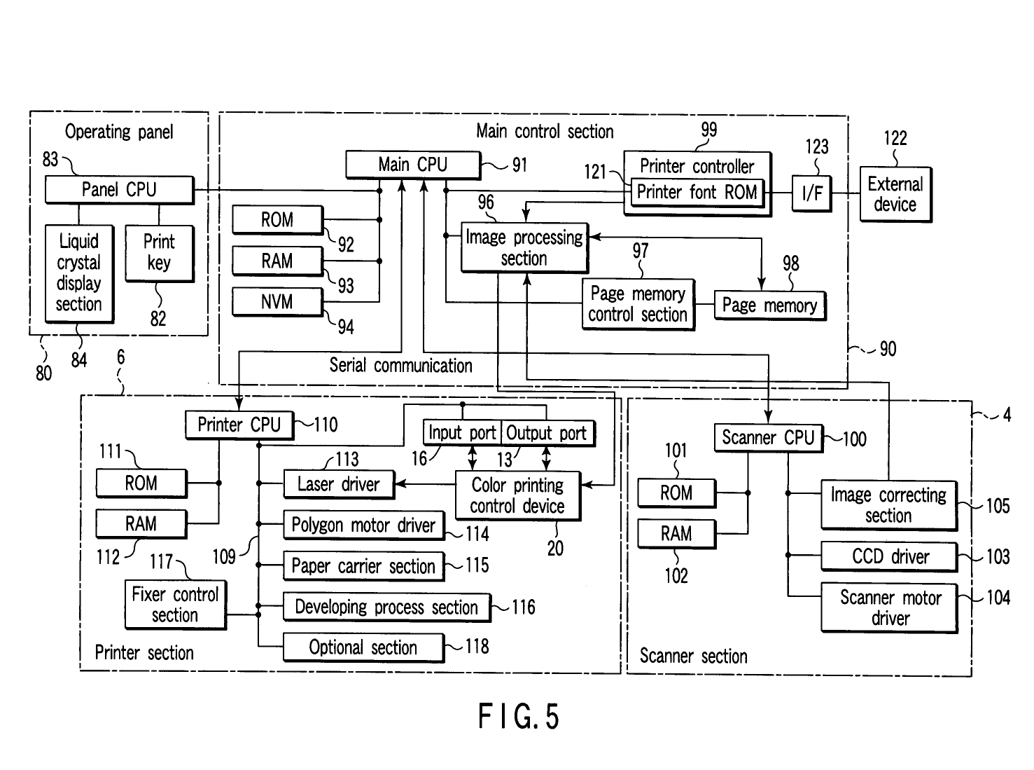

Hereinafter, embodiments of the present invention will be described with reference to the accompanying drawings. FIG. 1 is a view showing an example of displaying a basic screen at an operating section of an image forming apparatus according to the present invention. FIG. 2 is a view showing an example of displaying a photo zoom at the operating section. FIG. 3 is a view showing an example of displaying a photo zoom at the operating section. FIG. 4 is a sectional view showing an example of a configuration of the image forming apparatus according to the invention. FIG. 5 is a block diagram depicting an example of the configuration of the apparatus.

<Image Forming Apparatus According to the Present Invention>

(Mechanical Configuration)

Now, an example of the configuration of the image forming apparatus according to the present invention will be described here. FIG. 4 is a structural view illustrating an internal structure of the image forming apparatus. This image forming apparatus 1 is composed of: a color scanner section 4 serving as an image reading section; a printer section 6; an auto document feeder (hereinafter, simply referred to as an ADF) 7; an operating panel 80 described later and the like.

The scanner section 4 has the ADF 7 at an upper part thereof, and comprises a document stage 8 which is arranged opposed to the ADF 7 placed in its closed state, and which is composed of a transparent glass on which a document is set. Below the document stage 8, an exposure lamp 25 and a first mirror 26 are fixed to a first carriage 27. The exposure lamp 25 illuminates a document placed on the document stage 8. The first mirror 26 focuses the light from the exposure lamp 25 and deflects the reflection light from the document in the left direction with respect to the drawing, for example.

The first carriage 27 is allocated to be movable in parallel to the document stage 8. This carriage is reciprocally moved below the document stage 8 by means of a scanning motor (not shown) via a belt with teeth (not shown).

In addition, a second carriage 28 which is movable in parallel to the document stage 8 is arranged below the document stage 8. On the second carriage 28, second and third mirrors 30, 31 which sequentially deflect the reflection light from the document, deflected by the first mirror 26, are mounted each other at a right angle. The second carriage 28 is followed with respect to the first carriage 27 by the belt with teeth or the like (not shown) for driving the first carriage 27, and is moved in parallel to the first carriage 27 along the document stage 8 at a speed which is ½ of a normal speed.

An image focusing lens 32 for focusing the reflection light from the third mirror 31 on the second carriage 28; and a photoelectric converter element (hereinafter referred to as CCD) 34 for receiving and photo-electrically converting the reflection light focused by the image focusing lens are arranged below the document stage 8. The image focusing lens 32 is arranged to be movable via a drive mechanism in a face which includes an optical axis of the light deflected by the third mirror 31. Then, the image focusing lens itself moves, thereby focusing the reflection light as an image at a desired magnification. The incident reflection light is then photo-electrically converted by the CCD 34, and the CCD 34 outputs an electrical signal which corresponds to the read document.

On the other hand, the printer section 6 comprises a laser exposure device 40 which acts as hidden image forming means. The laser exposure device 40 comprises: a semiconductor laser serving as a light source; a polygon mirror serving as a scanning member for continuously deflecting the laser light emitted from the semiconductor laser; a polygon motor serving as a scanning motor for rotationally driving the polygon mirror at a predetermined rotation frequency; and an optical system for deflecting the laser light from the polygon mirror and guiding the deflected laser light to a photosensitive drum 44 described later.

In addition, the printer section 6 has the rotational photosensitive drum 44 serving as an image carrier arranged at a substantial center of the apparatus main body. The peripheral face of the photosensitive drum 44 is exposed by the laser light from the laser exposure device 40, and a desired hidden electrostatic image is formed. An electrification charger 45, a developer unit 46 and a transfer charger 48 are allocated at the periphery of the photosensitive drum 44. The electrification charger 45 electrifies the drum peripheral face at a predetermined charge. The developer unit 46 supplies a toner which serves as a developer to the hidden electrostatic image formed on the peripheral face of the photosensitive drum 44 and develops an image at a desired image density. The transfer charger 48 transfers the toner image formed on the photosensitive drum 44 to paper.

At the lower part in the apparatus main body, an upper cassette 52 and a lower cassette 53, each of which is retractable from the apparatus main body, are arranged in a state in which they are laminated on each other. A large capacity feeder 55 is provided laterally of these cassettes. A paper feed cassette 57 compatible with a manually inserting tray 56 is removably mounted above the large capacity feeder 55.

A resist roller pair 65 is provided at the upstream side of the photosensitive drum 44. The resist roller pair 65 corrects inclination of the removed copying paper and aligns a tip end of the toner image on the photosensitive drum 44 with a tip end of the copying paper. Then, this roller pair feeds the copying paper to a transfer belt unit 49 at a speed which is equal to a movement speed on the peripheral face of the photosensitive drum 44.

In addition, an operating panel 80 for inputting a copying start signal for establishing a variety of copying conditions and starting a copying operation is provided at the front upper part of the apparatus main body. The operating panel 80 is composed of a print key 82, a panel CPU 83, and a liquid crystal display section 84, as shown in FIG. 5, for example. The print key 82 instructs that copying starts. The liquid crystal display section 84 displays the number of pages or the number of copies, and further displays a copying magnification or editing or guides a variety of operations. This liquid crystal display section 84 is provided with a touch panel.

(Electrical configuration)

In the block diagram depicted in FIG. 5, the image forming apparatus according to the present invention is composed of a control section using three central processing units (hereinafter referred to as CPU), i.e., a main CPU 91 incorporated in a main control section 90; a scanner CPU 100 of the color scanner section 4; and a printer CPU 110 of the color printer section 6. The main CPU 91 makes serial communication with the printer CPU 110 and issues an operating instruction, and the printer CPU 110 returns a status signal in response to this instruction. In addition, the main CPU 91 makes serial communication with the scanner CPU 100 and issues an operating instruction, and the scanner CPU 100 returns a status signal to the main CPU 91.

The operating panel 80 is connected to the main CPU 91. The main control section 90 is composed of a main CPU 91, a ROM 91, a RAM 93, an NVM 94, an image processing section 96, a page memory control section 97, a page memory 98, a printer controller 99, and an HDD 124.

The main CPU 91 controls a whole operation of the main control section 90. The ROM 92 stores a control program therein. The RAM 93 temporarily stores data.

The NVM (nonvolatile random access memory: nonvolatile RAM) 94 is provided as a nonvolatile memory backed up in batteries (not shown). This memory maintains data on the NVM 94 when power is turned OFF.

The page memory control section 97 stores or reads out image data in or from the page memory 98. The page memory 98 has a region which can store image data for a plurality of pages. This page memory is formed to enable storage of data obtained by compressing the image data from the scanner section 4 on a one page by one page basis. A printer font ROM 121 stores font data which corresponds to print data therein.

The printer controller 99 includes the printer font ROM 121. The print data from an external device 122 such as a personal computer is decompressed to image data by using the font data stored in the printer font ROM 121 at a resolution according to the data indicating the resolution assigned to the print data via an input port 16. Further, an external interface 123 makes communication of a variety of signals with the external device 122.

The scanner section 4 is composed of: the scanner CPU 100 for controlling a whole operation of the scanner section 4; a ROM 101 having a control program or the like stored therein; a RAM 102 for storing data; a CCD driver 103 for driving a CCD sensor 34; a scanner motor driver 104 for controlling rotation of a motor which moves the exposure lamp 25 and the mirrors 26, 30, and 31 or the like; an A/D converter circuit for converting an analog signal from the CCD sensor 34 to a digital signal; a shading correcting circuit for correcting a dispersion of the CCD sensor 34 or a fluctuation of a threshold level in response to an output signal from the CCD sensor 34 caused by an ambient temperature change; and a image correcting section 105 including a line memory for temporarily storing a digital signal shading-corrected from the shading correcting circuit.

The printer section 6 is composed of: the printer CPU 110 for controlling a whole operation of the printer section 6; a ROM 111 having a control program or the like stored therein; a RAM 112 for storing data; a laser driver 113 for turning ON/OFF light emission (exposure) using a semiconductor laser; a polygon motor driver (motor control device) 114 for controlling rotation of a polygon motor of a laser unit; a paper carrier section 115 for controlling carriage of paper using a carrier passage; the electrification charger 45; the developer unit 46; a developing process section 116 for carrying out electrification, developing, and transfer by using the transfer charger 48; a fixer control section 117 for controlling a fixer unit 60 and an optional section 118; an output port 13; the input port 16; and an image forming apparatus 20 according to an embodiment of the present invention.

The image processing section 96 and the page memory 98 are connected to each other so as to transmit and receive image data. The image correcting section 105 and the color printing control device 20 are connected to each other so as to transmit and receive image data. Similarly, the printer controller 99 and the image processing section 96 are connected to each other so as to transmit and receive image data.

<Processing of Photographic Document in Image Forming Apparatus>

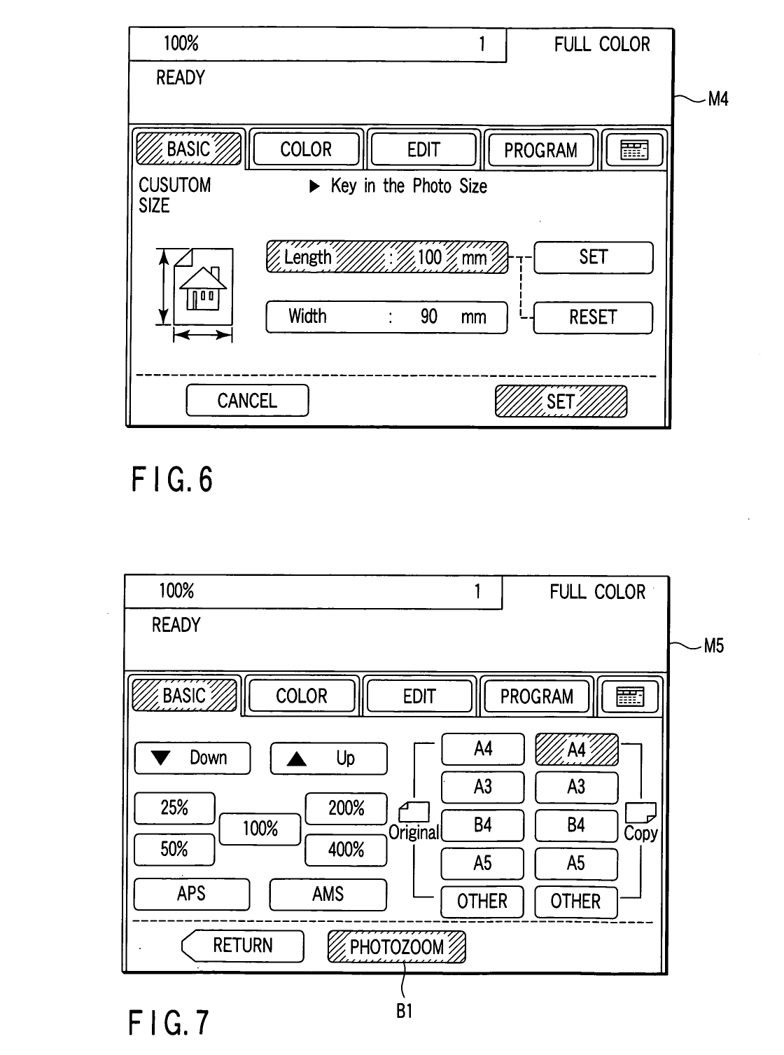

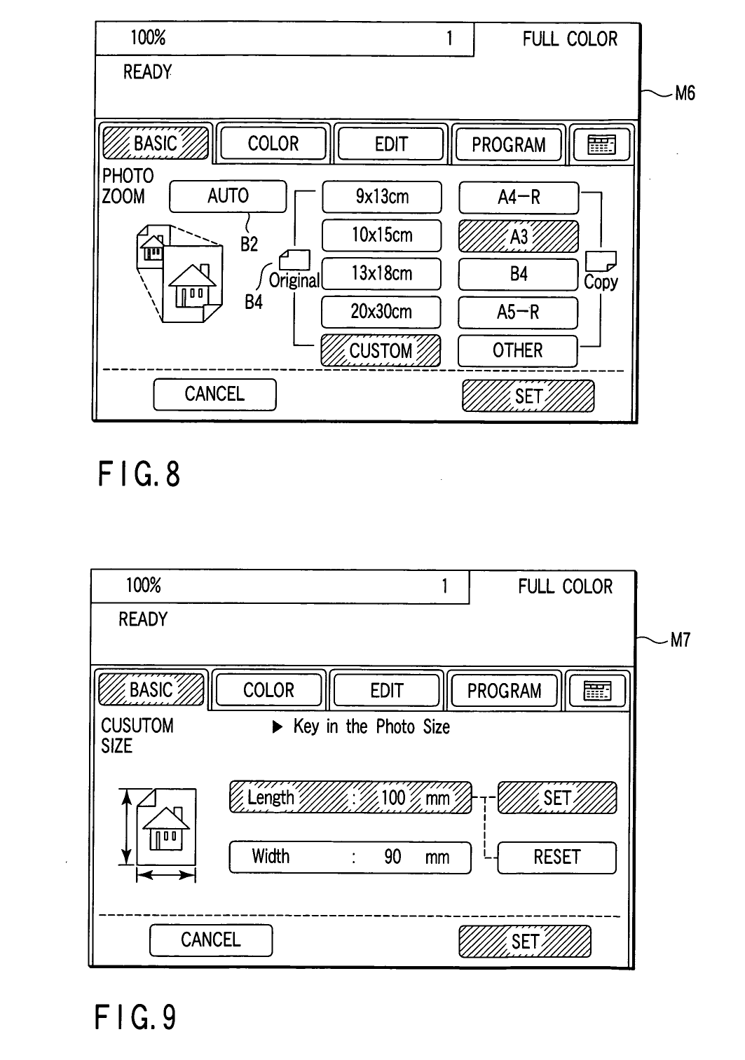

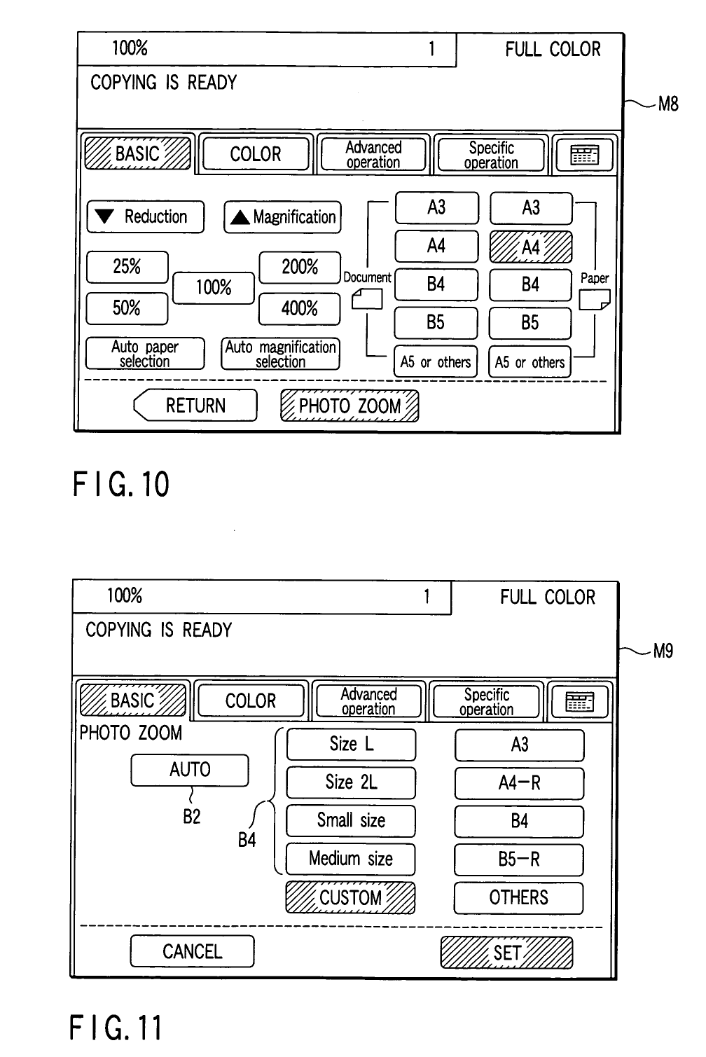

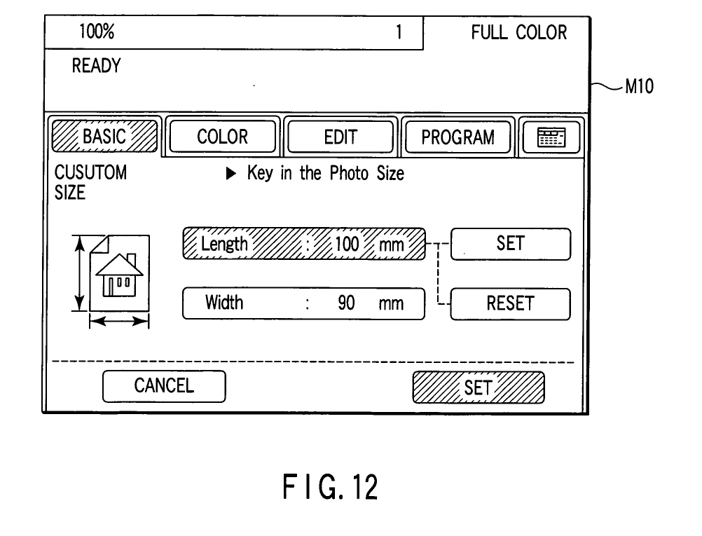

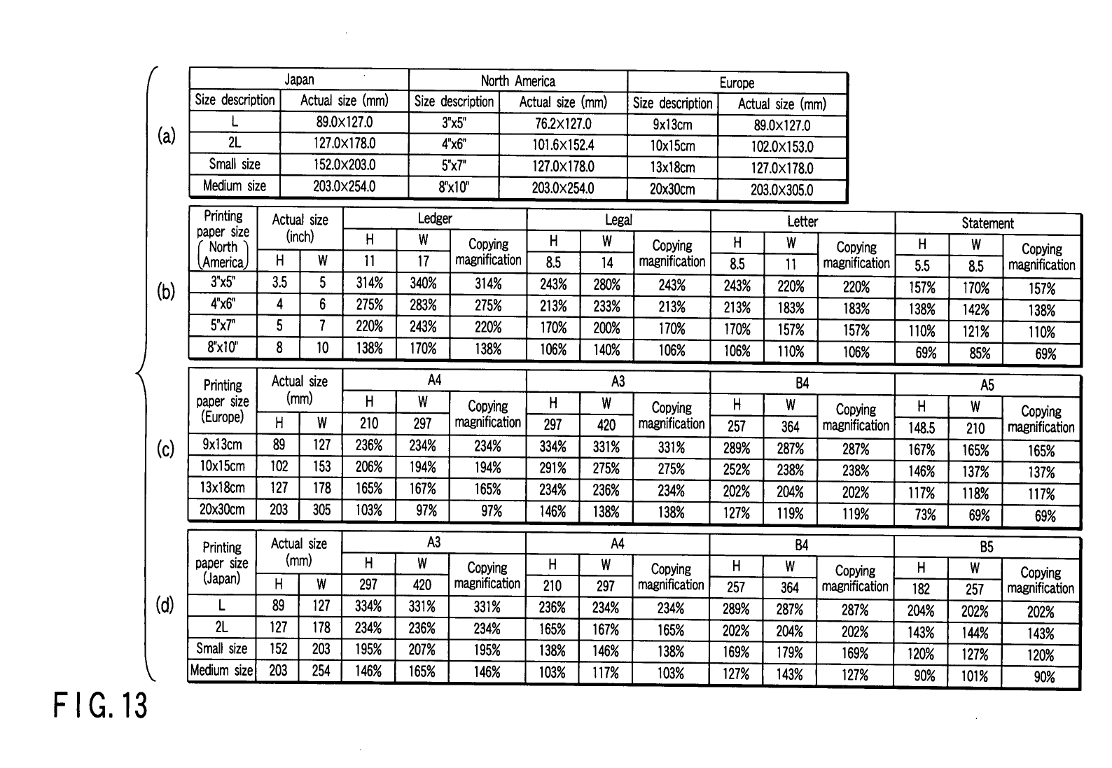

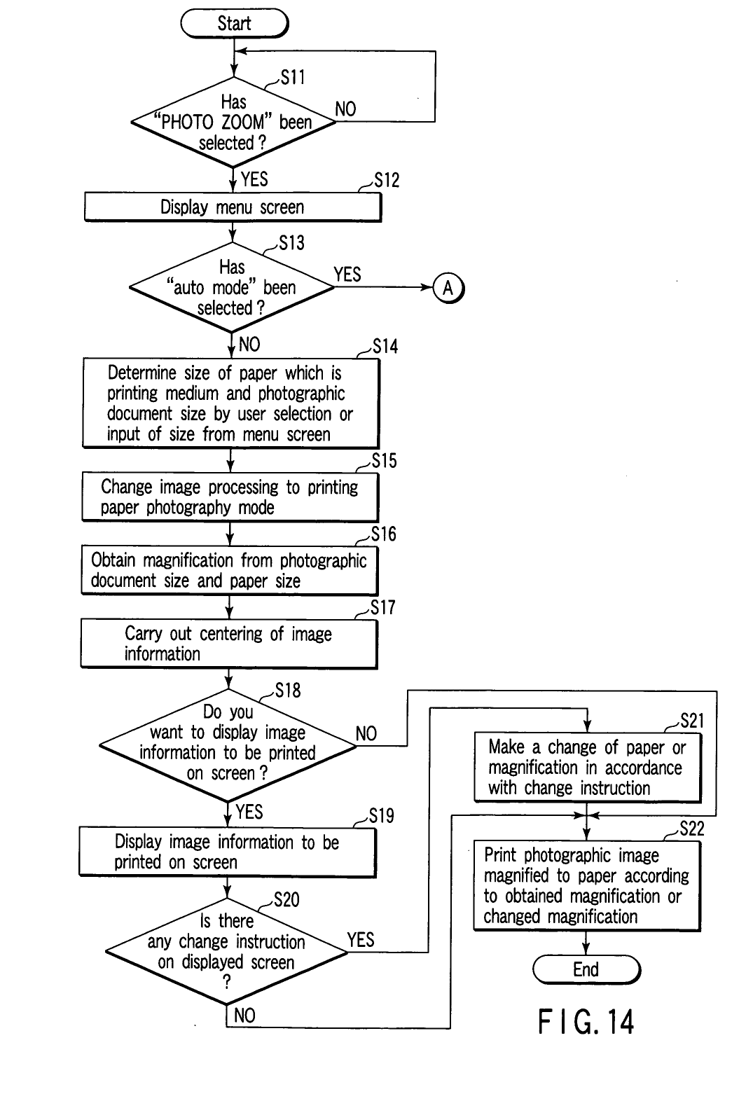

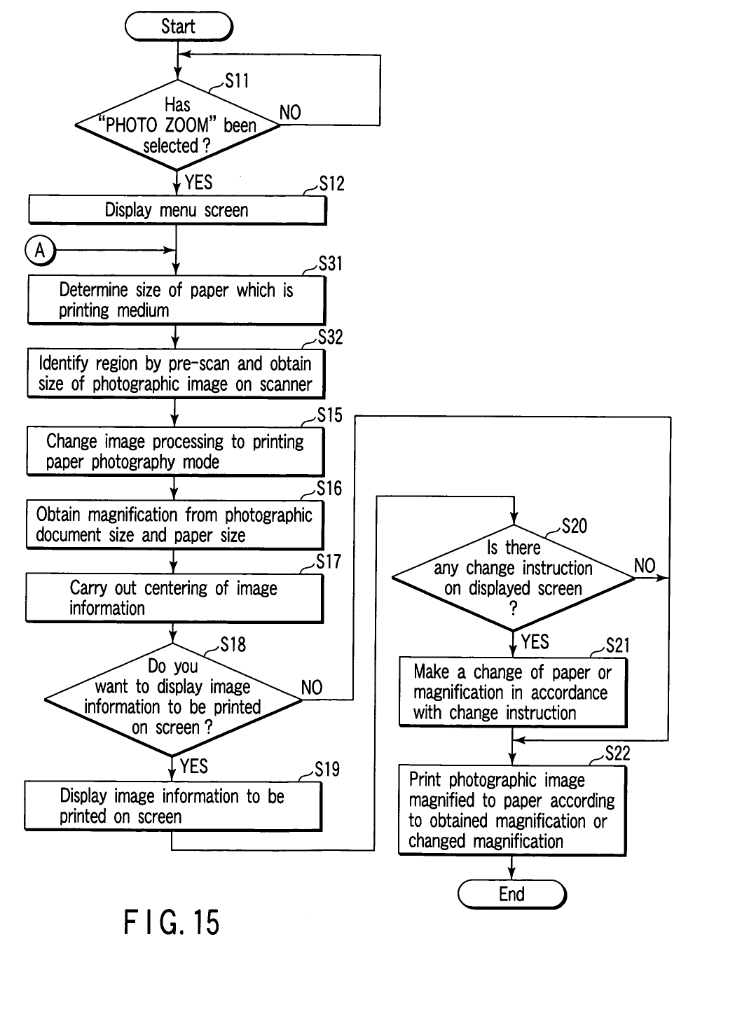

Now, an operating process for the above-described image forming apparatus to copy photographic printing paper or the like will be described below in detail with reference to the accompanying drawings including a flow chart and the like. FIG. 6 is a view showing an example of displaying a custom size at the operating section of the image forming apparatus; FIG. 7 is a view showing an example of displaying a basic screen at the operating section; FIG. 8 is a view showing an example of displaying a photo zoom at the operating section; FIG. 9 is a view showing an example of displaying a custom size at the operating section; FIG. 10 is a view showing an example of displaying a basic screen at the operating section; FIG. 11 is a view showing an example of displaying a photo zoom at the operating section; FIG. 12 is a view showing an example of displaying a custom size at the operating section; FIG. 13 is a view showing a relationship among a printing paper size name, an actual size and a copying magnification handled by the image forming apparatus; FIG. 14 is a flow chart showing an example of a copying process of a photographic document; and FIG. 15 is a flow chart showing an example of a copying process with automatic size recognition of the photographic document.

A copying process of the image forming apparatus 1 according to the present invention is achieved by the main CPU 91 of the main control section 90 executing an operating program stored in the ROM 92 or the like. An operating screen of the image forming apparatus 1 according to the invention is displayed on the liquid crystal display section 84 or the like of the operating panel 80. An example of the basic screen is shown in FIG. 1. A basic screen M1 of FIG. 1 is destined to North America. From this basic screen M1, when a PHOTO ZOOM button B1 is selected by the user operation (S11), an operating screen M2 (destined to North America) of FIG. 2 is displayed (S12).

When the operating screen M2 (destined to North America) of FIG. 2 is displayed in step S12, the user can select an auto mode on this screen by specifying an AUTO button B2 (S13). In the case where the auto mode is not selected, an operating screen M3 shown in FIG. 3 is displayed.

Here, in particular, if the AUTO button B2 is not selected, a manual mode is selected. The user can manually select one of four types of sizes for photographic printing paper as a document size, and further, can select one paper as a recording medium to be printed (S14). For example, “3 inches×5 inches” can be set for a document size, and “LT-R” can be set for a paper size.

In the case where a desired size button does not exist on the screen of FIG. 2, the user can change a current screen to an operating screen M4 of FIG. 6 and input an actual size of a photographic document by selecting a CUSTOM button B3.

On the other hand, in response to a selection of the PHOTO ZOOM button B1 in step S11, image processing in accordance with a printing paper photography mode is automatically selected and executed. In the image processing of the image processing section 96, the subject of image processing is an image having gradation property. Here, in the case where, for example, the image correcting section 105 or image processing section 106 determines that the gradation property of document image information read by the scanner section 4 is an image whose density distribution has gradation property of a photographic image or the like regardless of whether or not the PHOTO ZOOM button B1 is selected, it is preferable that the image processing section 96 applies image processing in accordance with the printing paper photography mode based on the determination at this time.

Next, according to the size of the photographic document determined by the user input and the size of paper which is a recording medium, the magnification for the copying process is determined based on a database (stored in the RAM 93 or the like, for example) shown in the chart of FIG. 13. FIG. 13A shows a database which indicates a relationship between a size name and an actual size in three destinations, Japan, North America, and Europe. FIG. 13B shows a database which indicates a magnification between a printing paper size and a paper size in the size standard destined to North America. FIG. 13C shows a database which indicates a magnification between a printing paper size and a paper size in the size standard destined to Europe. FIG. 13D shows a database which indicates a magnification between a printing paper size and a paper size in the size standard destined to Japan.

In the database destined to North America in FIG. 13B, when a document size is “3 inches×inches” and, a paper size is “LT-R”, a magnification of 220% is automatically determined (S16). This magnification is determined in consideration of the fact that an aspect ratio is different from another between a photographic document and a paper. Then, image information centering is carried out (S17), whereby a photographic image magnified to a proper size is formed at a substantial center of the paper.

Here, it is preferable that the magnification database for providing a certain degree of a blank be separately provided with respect to printing of the photographic image on the paper. When a user selectable mode is set as a blank mode, the blank mode is selected, thereby making it possible to form an image at the center of the paper in a state in which the photographic image has a proper blank.

After image magnification and centering have been carried out, in the case where a screen has a margin for display capacity (S18), it is preferable that image information to be printed be displayed on the operating screen (S19). If the user attempt to make any change (S20), it is possible to supply a change instruction on the operating screen M2 or the like of FIG. 2 and an operating screen (not shown) for directly inputting a magnification; to change a magnification; to change a display position; and to change paper (S21).

According to the thus determined magnification, the image processing section 96 or the like generates image information to be printed by magnifying an image or moving its position. Then, this image information is supplied to the printer section 6, and is formed on the specified paper which is a recording medium (S22).

On the other hand, in step S13, when the AUTO button B2 is selected, processing goes to auto mote processing of FIG. 15. The processing of FIG. 15 is similar to a process for copying a photographic document of FIG. 14 except step S31 and step S32.

That is, when the paper size serving as a recording medium is determined on the operating screen M2 or the like (S31), region recognition of a document image is carried out by means of pre-scan or the like, and the size of a photographic image on the scanner is obtained (S32). Here, the screen density distribution detected by the image processing section 96 or the like is detected; the image gradation property is determined; it is sensed that the current document is a photographic document; and further, it is determined what size of the photographic image exists. In this manner, even if the size of the photographic document is automatically determined even if it is not manually specified by the user operation. In addition, the PHOTO ZOOM button B1 is selected from the operating screen M1 or the like of FIG. 1, whereby it is preferable to determine that the current document is a photographic document and determine that the photo-graphic copying process is subsequently carried out. The processes in and after step S32 are identical to those in or after step S15 in FIG. 14. A duplicate description is omitted here.

Although a selection of the auto mode or manual mode may be determined by the AUTO button B2 on the operating screen M2 or the like of FIG. 2, it is preferable that the auto mode be selected in default settings provided on the operating panel 80.

As has been described in detail, in the image forming apparatus according to the invention, there is provided an image forming apparatus and an image forming method which handle a photographic document, the apparatus and method being adaptable to a case in which the photography size does not conform to the Japanese standard or a case in which the size is automatically detected.

(Other Specification)

Further, although the operating screen destined to North America is shown in FIGS. 1 to 3 and 5 in the image forming apparatus according to the invention, the operating screen destined to Europe is shown in FIGS. 7 to 9, and the operating screen destined to Japan is shown in FIGS. 10 to 12.

There are a variety of photographic printing paper sizes, and standard sizes are also various on a country by country basis. Thus, it is preferable that a standard photography size according to its destination (for example, Europe) be set as a default according to the destination information possessed by a copying machine. However, it is preferable to properly change a destination by making an operation of changing the destination from Japan to Europe, i.e., by storing plural items of destination information in the image forming apparatus, for example, calling a service mode through an operation of turning the power in a state in which a plurality of switches are pressed, and inputting a predetermined code from the service mode screen. Further, this destination changing process may be carried out on the screen for determining a default value from the operating screen displayed immediately after turning ON the power, and is not limited thereto.

In addition, as shown in the figure, it is preferable to change the standard printing paper size according to the destination information as well as paper size according to the destination, as is the case with sequence A, sequence AB, and letter sequence.

Although there are four default photographic printing paper sizes and one custom size in the above-described embodiment, even if the standard photographic document size in that region is provided as a default, some users may mainly use a size other than such default sizes provided in advance by the copying machine, and thus, all buttons may be custom-set. The number of buttons may be increased or decreased by the user. Further, the name displayed for the custom-set button may be arbitrarily set by the user.

With respect to centering which has been difficult to ensure precise allocation at the center of the paper, it is preferable to automatically allocate a document at the center of the paper. This is accomplished by the copying machine calculating an offset amount in a main scanning direction and a subsidiary scanning direction based on information on printing paper size of the photograph stored in advance or stored in custom setting and paper size. This calculation is carried out merely by setting a document according to a reference position on the document stage.

(Arbitrary Selection of Photography Size Sequence)

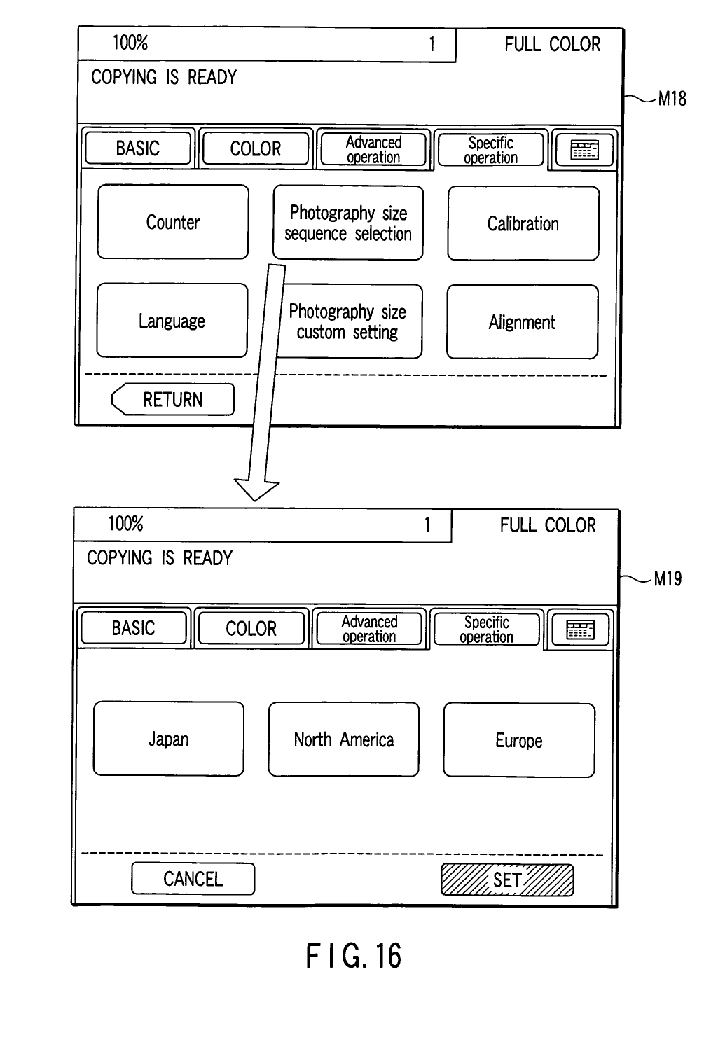

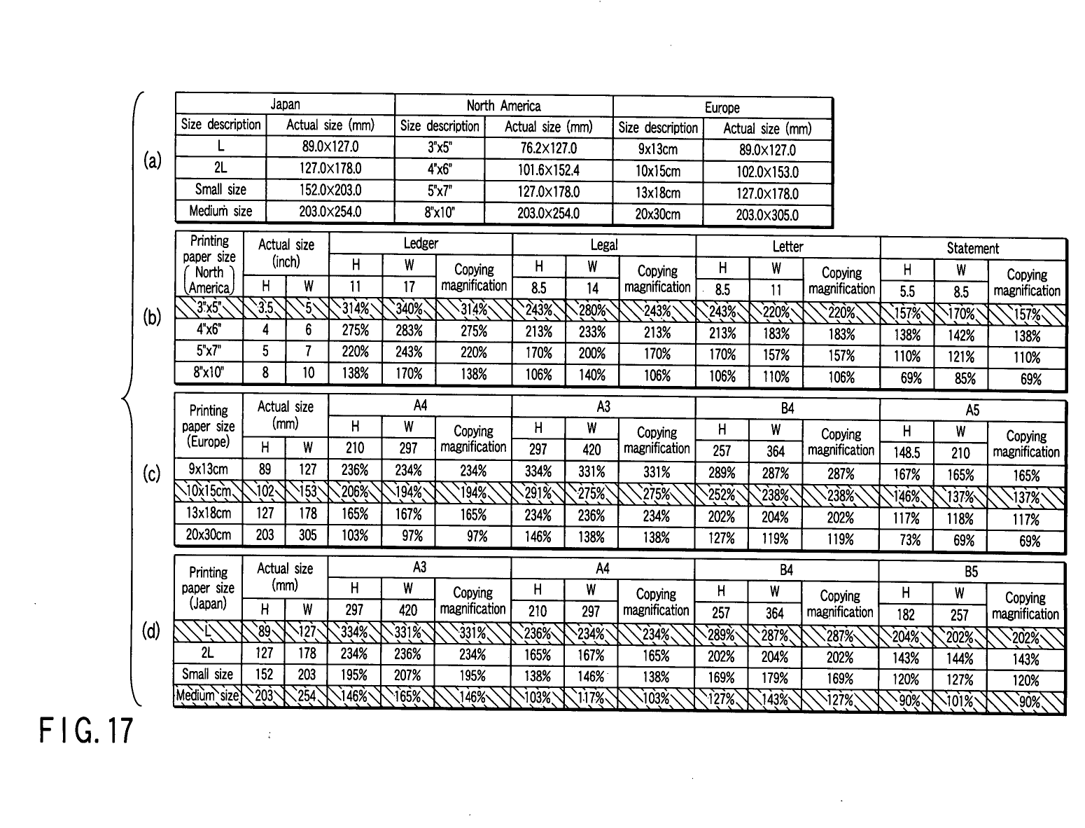

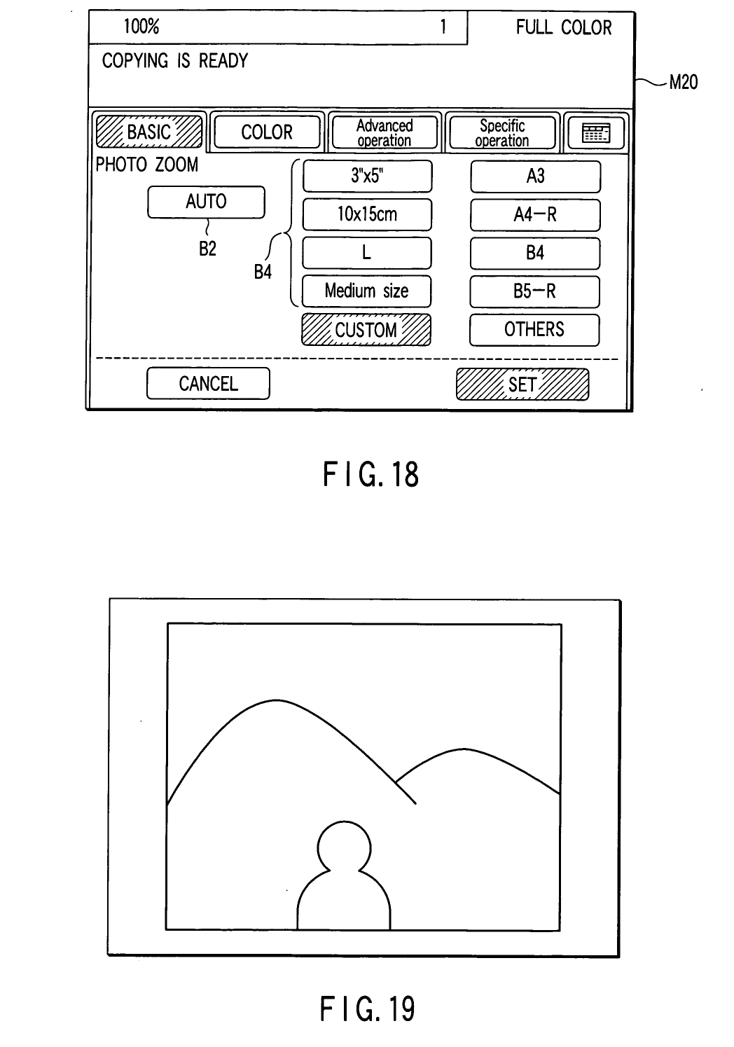

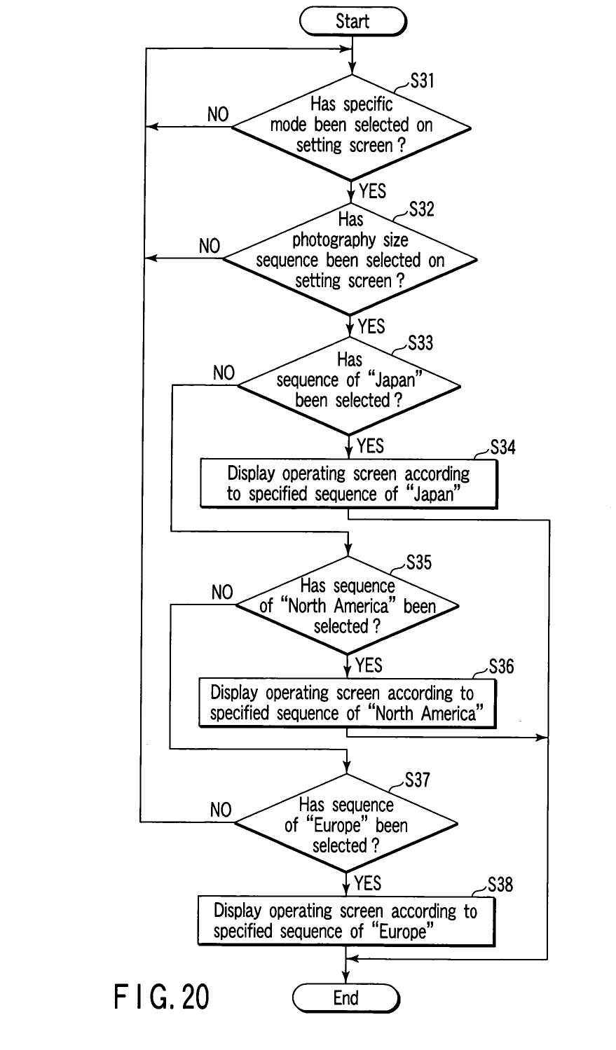

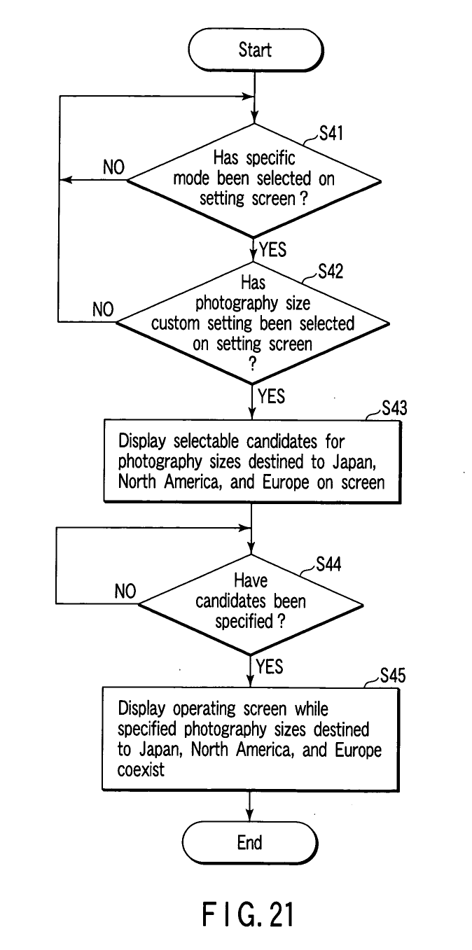

An arbitrary selection of a photography size sequence will be described below in detail with reference to the accompanying drawings. FIG. 16 is a view showing an example of an operating screen for selecting a photographic size sequence in the image forming apparatus; FIG. 17 is a view showing an example of an operating screen for selecting an arbitrary photographic size in the image forming apparatus; FIG. 18 is a view showing an example of an operating screen depending on an arbitrary photographic size in the image forming apparatus; FIG. 19 is a view showing an example of a photographic image outputted by the image forming apparatus; FIG. 20 is a view showing an example of a flow chart when selecting an arbitrary photographic size sequence in the image forming apparatus; and FIG. 21 is a view showing an example of a flow chart when selecting an arbitrary photographic size sequence in the image forming apparatus.

That is, in the image forming apparatus according to one embodiment of the present invention, as shown in the operating screen of FIG. 16, it is possible to freely set a photography size sequence destined to Japan, North America, or Europe by a user operation. In this manner, it is possible to arbitrarily change a photography size sequence, for example, from the sequence destined to Japan (FIG. 11) to the sequence destined to North America (FIG. 3) according to the user convenience as well as to set the photography size sequence at the factory or the like for the shipment destination of the image forming apparatus. Therefore, also with respect to a photograph sent from North America after handling an arbitrary photograph of the photography size destined to Japan, similarly, it is possible to carry out a process for magnifying a current paper size to an arbitrary paper size while the operating screen is changed to the photography size sequence (FIG. 3) destined to North America.

This changing operation will be described below with reference to the flow chart of FIG. 20. In the flow chart shown in FIG. 20, the image forming apparatus 1 carries out, for example, an arbitrary selection process of a photography size sequence under the control of the panel CPU 83 and the main CPU 91. First, on the operating screen shown in FIG. 16, a specific mode is selected by the user on the setting screen (S31). Further, in this specific mode setting screen M18, it is determined whether or not a “photography size sequence selection” has been selected (S32). In the case where the “photography size sequence selection” has been selected, the operating screen M18 is further changed to an operating screen M19. When a sequence of “Japan” is assumed to have been selected by the user (S33), the specified sequence of “Japan” is registered. In this manner, when a “photo zoom” is selected in a basic mode of FIG. 10 by the user operation, the current screen is changed to a screen M9 for setting a photography size and a paper size in the sequence of “Japan” as shown in FIG. 11 (S34).

In the case where the sequence of “Japan” is not selected by the user in step S33, it is then determined whether or not a sequence of “North America” has been selected (S35). When the sequence of “North America” is assumed to have been selected by the user, the specified sequence of “North America” is registered. In this manner, when a “photo zoom” B1 is selected in the basic mode of FIG. 1 by the user operation, the current screen is changed to a screen M2 for setting a photography size and a paper size in the sequence of “North America” as shown in FIG. 2 (S36).

Further, when the sequence of “North America” is not selected by the user in step S35, it is then determined whether or not a sequence of “Europe” has been selected (S37). When the sequence of “Europe” is assumed to have been selected by the user, the specified sequence of “Europe” is registered. In this manner, when the “photo zoom” B1 is selected in the basic mode of FIG. 7 by the user operation, a screen M6 for setting a photography size and a paper size in the sequence of “Europe” as shown in FIG. 8 is displayed (S38). According to this setting screen, the desired photography size and paper size are specified, and a photographic image is magnified at a proper copying magnification, as shown in FIG. 19, making it possible to obtain an image centered at the center of the paper.

As described above, it becomes possible to select an arbitrary photography size sequence at any timing by the user's arbitrary operation. Thus, for example, a photo zoom process can be carried out for a photograph of size in the sequence of Japan, a photograph of size in the sequence of North America, or a photograph of size in the sequence of Europe.

Service Personnel Setting

It is preferable that a process for changing the above-described photography size sequence be carried out by only specialists such as service personnel. That is, in the image forming apparatus 1, only service personnel can carry out the changing process under the control of the panel CPU 83 and the main CPU 91. A predetermined keyword is inputted so as not to be recognized by a general user, whereby this changing process is programmed so as to be carried out only in the case where a predetermined operation has been made. The operation carried out by service personnel denotes an operation which is not described in the operating manual for the image forming apparatus 1, for example, an operation specified by simultaneously pressing operating keys which are not generally pressed at the same time. It is preferable that this operation be carried out by such an operation which is not carried out in normal operation similarly in a normal state rather than when power is turned ON.

When the desired operation as described above is made, the current mode is changed to a change mode. When a numeric key “1” is pressed in response to this change mode, an operation “destined to Japan” can be made. When a numeric key “2” is pressed in response to this change mode, an operation “destined to North America” can be made. When a numeric key “3” is pressed in response to this change mode, an operation “destined to Europe” can be made. In addition, a method which cannot be easily carried out by the user or the like, for example, a method for reading a recording medium such as a memory card, carrying out an authenticating process, and then, selecting a sequence can be made in the similar manner.

(Arbitrary Selection of Photography Size According to Sequence)

Next, an arbitrary selection of a photography size according to a sequence will be described below. That is, according to this operation, as shown in the operating screen of FIG. 18, a combination of operations destined to Japan, North America, and Europe can be freely used in each size in these sequences without being limited to any one of the above destined operations. In FIG. 18, “3″×5″” which is one of the sizes destined to North America, “10 cm×10 cm” which is one of the sizes destined to Europe, and “L” and “Medium size” which are the sizes destined to Japan are displayed at the same time on one operating screen.

Now, an arbitrary selection process of a photography size according to a sequence will be described in detail with reference to the flow chart shown in FIG. 21. That is, in the image forming apparatus 1, when the specific mode setting screen M18 as shown in FIG. 16 is first selected on the setting screen M18 under the control of the panel CPU 83, the main CPU 91 and the like (S41), it is determined whether or not the photography size custom setting has been selected on this setting screen (S42). When the photography size custom setting is selected, a selectable setting screen indicating candidates of photography sizes destined to Japan, North America, and Europe is displayed as shown in FIG. 17 (S43). Here, according to the user operation, as shown in FIG. 17, “3″×5″” which is one of the sizes destined to North America, “10 cm×15 cm” which is one of the sizes destined to Europe, and “L” and “Medium size” which are the sizes destined to Japan are selected as the candidates (S44). On the operating screen of FIG. 17, it is preferable that selection be made by differentiating a color or the like in a screen region of a selected size from its periphery. In this manner, the specified candidate is registered, thereby making it possible to display the sizes of each arbitrary sequence as shown in FIG. 18 (S45). That is, by this arbitrary selection process of the photography sizes, it becomes possible to arbitrary set the photography sizes that the are frequently used by the user without being limited to any of the sequences. In an environment whose usability is very good for the user, it becomes to carry out a photo zoom process according to one embodiment of the present invention.

One skilled in the art can achieve the present invention according to a variety of the above-described embodiments. Further, a variety of modifications to these embodiments can be easily conceived by one skilled in the art, making it possible to apply the modifications to the variety of embodiments even if they have any inventive ability. Therefore, the present invention covers a broad scope without departing from the disclosed principle and novel features, and is not limited to the above-described embodiments.

1. An image forming apparatus comprising:
a reading section which reads an image of a gradation document placed on a document stage;
a selecting section which selects any one of an auto mode and a manual mode;
a determining section which, when the manual mode has been selected by the selecting section, determines a size of the gradation document in response to a user instruction, and, when the auto mode has been selected by the selecting section, automatically detects and determines a size of the gradation document read by the reading section;
an image processing section which determines a magnification based on the size of the gradation document determined by the determining section and a size of a recording medium set in response to the user instruction, and magnifies the image of the gradation document according to the determined magnification; and
an image forming section which forms an image on the recording medium based on image information processed by the image processing section.

2. An image forming apparatus according to claim 1, wherein, when it is determined that a gradation image is produced from a density distribution of the image of the gradation document read by the reading section, the image processing section applies image processing in accordance with a printing paper photography mode to the image.

3. An image forming apparatus according to claim 1, wherein, according to an image forming position at which the image of the gradation document read by the reading section is formed on the recording medium, the image processing section carries out centering in consideration of an aspect ratio of the gradation document and the recording medium, and carries out a magnification process according to the determined magnification.

4. An image forming apparatus according to claim 1, wherein the determining section determines a size of the gradation document according to a value inputted by the user.

5. An image forming apparatus according to claim 1, wherein the determining section displays on a screen at least one of photography sizes corresponding to destinations as a photography size serving as an option of size of the gradation document such that a user can select the photography size.

6. An image forming apparatus according to claim 1, wherein the determining section displays on a screen at least one of 3 inches×5 inches, 4 inches×6 inches, 5 inches×7 inches, and 8 inches×12 inches which are photography sizes under a North America standard, at least one of 9 cm×13 cm, 10 cm×15 cm, 13 cm×18 cm, and 20 cm×30 cm which are photography sizes under an European standard, or at least one of size L, size 2L, small size, and medium size which are photography sizes under a Japanese standard as a photography size serving as an option of size of the gradation document such that a user can select the photography size.

7. An image forming apparatus according to claim 1, further comprising:
a control section which displays a plurality of sequences of sizes of a gradation document on an operating screen; displays candidates of sizes of the gradation document in accordance with one specified sequence; determines a magnification based on the size of the gradation document determined by the image processing section; and controls the image processing section so as to magnify an image of the gradation document according to the determined magnification.

8. An image forming apparatus according to claim 6, wherein a process for selecting a sequence of the control section can be operated by only service personnel and can be executed only in the case where a predetermined keyword has been inputted or a predetermined operation has been made so as not to be recognized by a general user.

9. An image forming apparatus according to claim 1, further comprising:
a control section which displays a plurality of sizes of a gradation document according to a plurality of sequences on an operating screen; registers a plurality of sizes of an arbitrary gradation document specified from among the sizes; displays the plurality of registered sizes of the arbitrary gradation document as candidates for the sizes of the gradation document at the same time; in accordance with one specified size of the gradation document, determines a magnification based on the size of the gradation document determined by the image processing section; and controls the image processing section so as to magnify an image of the gradation document according to the determined magnification.

10. An image forming apparatus according to claim 1, further comprising:
a control section which displays a plurality of sequences destined to Japan, North America, or Europe, of sizes of a gradation document on an operating screen; displays candidates for the sizes of the gradation document in accordance with one specified sequence; in accordance with one specified size of the gradation document, displays candidates for the sizes of the gradation document; in accordance with one specified size of the gradation document, determines a magnification based on the size of the gradation document determined by the image processing section;
and controls the image processing section so as to magnify an image of the gradation document according to the determined magnification.

11. An image forming apparatus according to claim 10, wherein a process for selecting a sequence of the control section can be operated by only service personnel and can be executed only in the case where a predetermined keyword has been inputted or a predetermined operation has been made so as not to be recognized by a general user.

12. An image forming apparatus according to claim 1, further comprising:
a control section which displays a plurality of sequences destined to Japan, North America, or Europe, of sizes of a gradation document on an operating screen; registers a plurality of sizes of an arbitrary gradation document specified from among the sizes; displays the plurality of registered sizes of the arbitrary gradation document as candidates for the sizes of the gradation document at the same time; in accordance with one specified size of the gradation document, determines a magnification based on the size of the gradation document determined by the image processing section; and controls the image processing section so as to magnify an image of the gradation document according to the determined magnification.

13. An image forming apparatus according to claim 1, further comprising:
a control section which displays on an operating screen at least one of 3 inches×5 inches, 4 inches×6 inches, 5 inches×7 inches, and 8 inches×12 inches which are photography sizes under a North America standard, at least one of 9 cm×13 cm, 10 cm×15 cm, 13 cm×18 cm, and 20 cm×30 cm which are photography sizes under an European standard, or at least one of size L, size 2L, small size, and medium size which are photography sizes under a Japanese standard; registers a plurality of sizes of an arbitrary gradation document specified from among the photography sizes; displays the plurality of registered sizes of the arbitrary gradation document as candidates for the sizes of the gradation document at the same time; in accordance with one specified size of the gradation document, determines a magnification based on the size of the gradation document determined by the image processing section; and controls the image processing section so as to magnify an image of the gradation document according to the determined magnification.

14. An image forming method comprising:
reading an image of a gradation document placed on a document stage;
selecting any one of an auto mode and a manual mode;
when the manual mode has been selected, determining a size of the gradation document in response to a user instruction, and, when the auto mode has been selected, automatically detecting and determining a size of the gradation document read by a reading section;
determining a magnification based on the determined size of the gradation document and a size of a recording medium set in response to the user instruction, and magnifying the image of the gradation document according to the determined magnification; and
forming an image on the recording medium based on image information processed by an image processing section.

15. An image forming method according to claim 14, wherein, according to an image forming position at which the image of the gradation document read by the reading section is formed on the recording medium, centering is carried out in consideration of an aspect ratio of the gradation document and the recording medium, and a magnification process is carried out according to the determined magnification.

16. An image forming method according to claim 14, wherein a size of the gradation document is determined according to a value inputted by the user.

17. An image forming method according to claim 14, wherein at least one of photography sizes corresponding to destinations is displayed on a screen as a photography size serving as an option of size of the gradation document such that a user can select the photography size.

18. An image forming method according to claim 14, further comprising:
displaying a plurality of sequences of sizes of sizes of a gradation document on an operating screen;
displaying candidates of sizes of the gradation document in accordance with one specified sequence;
determining a magnification based on the size of the gradation document determined by the image processing section in accordance with one specified size of the gradation document; and
controlling the image processing section so as to magnify an image of the gradation document according to the determined magnification.

19. An image forming method according to claim 14, wherein a process for selecting a sequence of the control section can be operated by only service personnel and can be executed only in the case where a predetermined keyword has been inputted or a predetermined operation has been made so as not to be recognized by a general user.

20. An image forming method according to claim 14, further comprising:
displaying a plurality of sizes of a gradation document according to a plurality of sequences on an operating screen;
registering a plurality of sizes of an arbitrary gradation document specified from among the sizes;
displaying the plurality of registered sizes of the arbitrary gradation document as candidates for the sizes of the gradation document at the same time;
in accordance with one specified size of the gradation document, determining a magnification based on the size of the gradation document determined by the image processing section; and
controlling the image processing section so as to magnify an image of the gradation document according to the determined magnification.
